(19) United States
(12) Patent Application Publication
(10) Pub. No.: US 2022/0154842 A1
(43) Pub. Date: May 19, 2022

(54) SOLENOID AND SOLENOID CONTROL DEVICE

(71) Applicants: HYUNDAI MOTOR COMPANY, Seoul (KR); KIA CORPORATION, Seoul (KR)

(72) Inventor: Jeong Hyun Ham, Jeonju-si (KR)

(73) Assignees: HYUNDAI MOTOR COMPANY, Seoul (KR); KIA CORPORATION, Seoul (KR)

(21) Appl. No.: 17/382,678

(22) Filed: Jul. 22, 2021

(30) Foreign Application Priority Data
Nov. 18, 2020 (KR) 10-2020-0154946

(51) Int. Cl. F16K 31/06; F16K 37/00

(52) U.S. Cl. CPC F16K 31/0679; F16K 37/0041

(57) ABSTRACT

A solenoid and a solenoid control device, the solenoid control device including: a solenoid having a first coil, a variable resistor connected to one end of the first coil in series, and a second coil connected with the first coil in parallel; a drive device that drives the solenoid by supplying power to the dual coils; and a controller that controls the solenoid through the drive device.

### CROSS-REFERENCE TO RELATED APPLICATION

This application claims the benefit of priority to Korean Patent Application No. 10-2020-0154946, filed in the Korean Intellectual Property Office on Nov. 18, 2020, the entire contents of which are incorporated herein by reference.

### TECHNICAL FIELD

The present disclosure relates to a solenoid and a solenoid control device.

### BACKGROUND

A solenoid is applied to a gas valve and/or a hydraulic valve in a vehicle. When an over-voltage higher than or equal to a rated voltage (or an over-current) is applied to the solenoid, the valve may fail, or may be cut off, due to heat abnormally generated from a solenoid coil. Accordingly, to reduce heat generated from the solenoid coil when an over-voltage is applied to the solenoid, a high-resistance coil may be applied to the solenoid to decrease the amount of current flowing in the solenoid coil, thereby reducing the amount of heat generated. However, due to the decrease in the amount of current flowing in the solenoid coil, the magnetic force of the solenoid may be decreased so that a load to press the valve may be reduced, leading to an increase in a possibility of internal leakage. Alternatively, a positive temperature coefficient (PTC) element may be connected to the solenoid coil in series. When an over-voltage is applied to the solenoid, the resistance of the PTC element may rapidly rise to reduce the amount of heat generated from the solenoid coil, thereby protecting the solenoid coil. However, as the resistance of the PTC element rapidly rises, power supplied to the solenoid coil may be interrupted, and a fuel valve may be unintentionally closed. In this case, supply of fuel to an engine may be stopped so that emergency braking may occur during travel, or it may be impossible to supply fuel into a stack, which may lead to degradation in the durability of the stack.

### SUMMARY

The present disclosure has been made to solve the above-mentioned problems occurring in the prior art while advantages achieved by the prior art are maintained intact.

An aspect of the present disclosure provides a solenoid to which dual coils and a positive temperature coefficient (PTC) element are applied for protection of the solenoid from an over-voltage or over-current. Another aspect of the present disclosure provides a solenoid control device.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a solenoid includes a first coil, a variable resistor connected to one end of the first coil in series, and a second coil connected with the first coil in parallel.

The first coil may be implemented with a coil having a relatively low resistance, compared to the second coil.

The variable resistor may be implemented with a PTC element.

The variable resistor may interrupt power applied to the first coil, when abnormal power is applied to the solenoid.

According to another aspect of the present disclosure, a solenoid control device includes a solenoid having dual coils, a drive device that drives the solenoid by supplying power to the dual coils, and a controller that controls the solenoid through the drive device.

The dual coils may include a first coil and a second coil connected with the first coil in parallel.

The first coil may be implemented with a coil having a relatively low resistance, compared to the second coil.

The solenoid may include a variable resistor connected to the first coil in series.

The variable resistor may be implemented with a PTC element.

The variable resistor may interrupt power applied to the first coil, when abnormal power is applied to the solenoid.

The controller may output a warning to inform of the application of the abnormal power to the solenoid.

### BRIEF DESCRIPTION OF THE DRAWINGS

The above and other objects, features, and advantages of the present disclosure will be more apparent from the following detailed description taken in conjunction with the accompanying drawings, in which:

FIG. 1 is a view illustrating a configuration of a solenoid control device according to embodiments of the present disclosure;

FIG. 2 is a view illustrating a solenoid valve according to embodiments of the present disclosure;

FIG. 3 is a view illustrating a current flow inside a solenoid in a normal power supply state according to embodiments of the present disclosure; and

FIG. 4 is a view illustrating a current flow inside the solenoid in an abnormal power supply state according to embodiments of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions has been omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

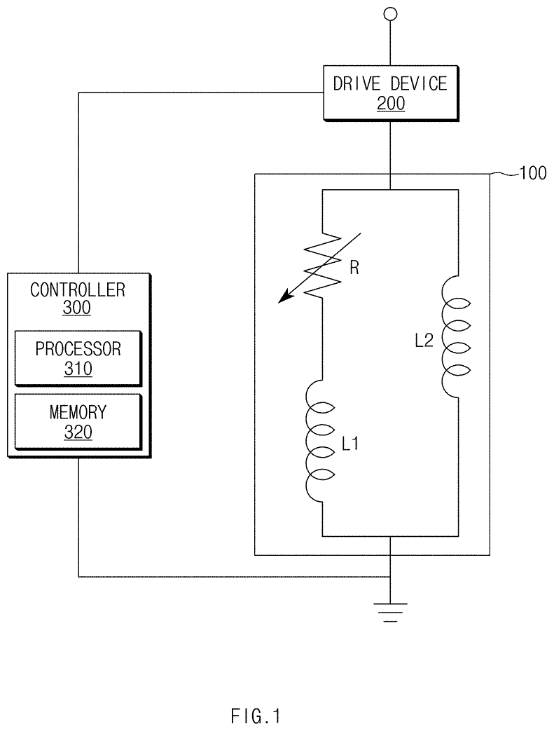

FIG. 1 is a view illustrating a configuration of a solenoid control device according to embodiments of the present disclosure.

Referring to FIG. 1, the solenoid control device may include a solenoid 100, a drive device 200, and a controller 300.

The solenoid 100 may be applied to a gas valve, a hydraulic valve, and/or a relay in a vehicle. The solenoid 100 may include dual coils, i.e., a first coil L1 and a second coil L2 connected with each other in parallel. In addition, the solenoid 100 may include a variable resistor R connected to the first coil L1 in series.

The first coil L1 may be disposed in parallel with the second coil L2. A contact point at which one end of the first coil L1 and one end of the second coil L2 meet each other may be connected to a ground. The first coil L1 may be a coil that has a relatively low resistance, compared to the second coil L2. In other words, the second coil L2 may be a coil that has a relatively high resistance, compared to the first coil L1. For example, the first coil L1 may be a low-resistance coil, and the second coil L2 may be a high-resistance coil.

One end of the variable resistor R may be connected to an opposite end of the first coil L1. A contact point at which an opposite end of the variable resistor R and an opposite end of the second coil L2 meet each other may be connected with a positive terminal B+ of a power supply. Here, the power supply may be a low-voltage battery (e.g., a 12-V battery) equipped in the vehicle.

The variable resistor R may be connected to the first coil L1 that has a relatively low resistance, compared to the second coil L2. A thermoelectric element, such as a positive temperature coefficient (PTC) element, may be used as the variable resistor R. The PTC element has a property by which resistance increases as ambient temperature rises. When an over-voltage or over-current is applied to the solenoid 100, the variable resistor R may interrupt power applied to the first coil L1 and may allow the second coil L2, which is a high-resistance coil, to generate a magnetic force alone.

The drive device 200 may supply power to the solenoid 100 or may interrupt the supply of power to the solenoid 100, according to an instruction of the controller 300. The drive device 200 may supply power to the first coil L1 and the second coil L2 of the solenoid 100 using the power supply (e.g., a 12-V battery) in the vehicle to generate a magnetic force inside the solenoid 100. The drive device 200 may include a relay, a switch, a converter, and/or a regulator.

The controller 300 may operate or stop the solenoid 100 through the drive device 200. The controller 300 may control an operation of the solenoid 100 by instructing the drive device 200 to supply or interrupt power. Furthermore, the controller 300 may adjust a magnetic force generated inside the solenoid 100 by controlling the supply of power to the solenoid 100 through the drive device 200.

When abnormal power (e.g., an over-voltage or over-current) is applied to the solenoid 100, the controller 300 may output a warning to inform of the application of the abnormal power to the solenoid 100. The controller 300 may detect the application of the abnormal power to the solenoid 100 using a current sensor and/or a voltage sensor. The controller 300 may output the warning in the form of visual information and/or auditory information using an output device (e.g., a display, a cluster, a speaker, and/or a buzzer). Furthermore, the controller 300 may guide the vehicle to a close repair shop in conjunction with a navigation terminal (not illustrated).

The controller 300 may include a processor 310 and a memory 320. The processor 310 may control an overall operation of the controller 300. The processor 310 may be implemented with an application specific integrated circuit (ASIC), a digital signal processor (DSP), programmable logic devices (PLDs), field programmable gate arrays (FPGAs), a central processing unit (CPU), microcontrollers, and/or microprocessors. The memory 320 may be a non-transitory storage medium that stores instructions executed by the processor 310. The memory 320 may be implemented with at least one of storage media such as a flash memory, a random access memory (RAM), a static random access memory (SRAM), a read only memory (ROM), a programmable read only memory (PROM), an electrically erasable and programmable ROM (EEPROM), an erasable and programmable ROM (EPROM), a register, or the like. In this embodiment, it is exemplified that the memory 320 is located inside the controller 300. However, without being limited thereto, the memory 320 may be located inside and/or outside the controller 300.

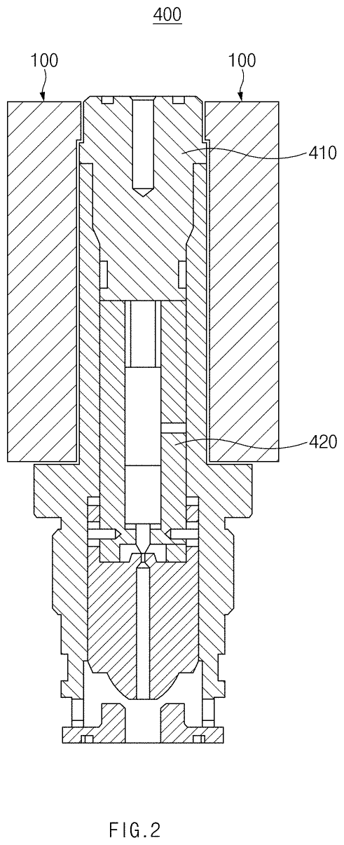

FIG. 2 is a view illustrating a solenoid valve according to embodiments of the present disclosure.

Referring to FIG. 2, the solenoid valve 400 may include the solenoid 100, a core 410, and a plunger 420.

The solenoid 100, as illustrated in FIG. 1, may include the dual coils L1 and L2 and the variable resistor R. When power is applied to the solenoid 100, a magnetic force is generated inside the solenoid 100 by the dual coils L1 and L2. The variable resistor R is connected in series to one of the dual coils L1 and L2 that has a relatively low resistance. When abnormal power is applied to the solenoid 100, the variable resistor R interrupts power applied to the low-resistance coil.

The core 410 and the plunger 420 may be diamagnetic bodies and may be magnetized by a magnetic force generated inside the solenoid 100. As the core 410 and the plunger 420 are magnetized, an attractive force may act between the core 410 and the plunger 420 to open the valve.

When power is supplied to the solenoid 100, the plunger 420 may be moved in one direction, for example, in a direction toward the core 410 by a magnetic force generated by the first coil L1 and the second coil L2. In other words, the plunger 420 may be moved toward the core 410 by an attractive force between the core 410 and the plunger 420. When the supply of power to the solenoid 100 is stopped, the plunger 420 may be moved in a direction opposite to the one direction by a repulsive force between the core 410 and the plunger 420 to return to the position before the supply of power. As the plunger 420 returns to the position before the supply of power, the valve may be closed.

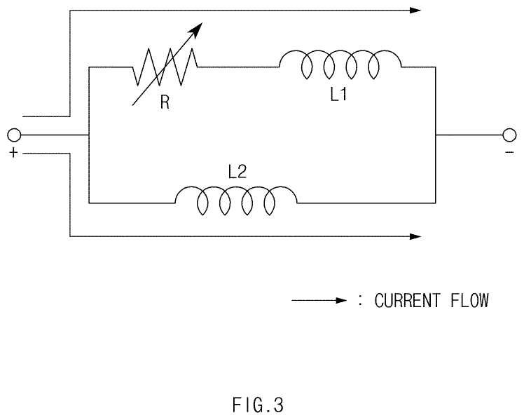

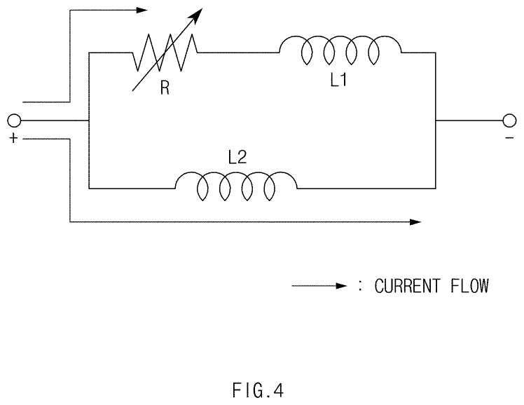

FIG. 3 is a view illustrating a current flow inside the solenoid in a normal power supply state according to embodiments of the present disclosure. FIG. 4 is a view illustrating a current flow inside the solenoid in an abnormal power supply state according to embodiments of the present disclosure.

Referring to FIG. 3, when normal power (e.g., a rated voltage or rated current) is applied to the solenoid 100, the total current applied to the solenoid 100 may be divided and supplied to the first coil L1 and the second coil L2. When the current is supplied to the first coil L1 and the second coil L2, the first coil L1 and the second coil L2 may generate a magnetic force inside the solenoid 100. The plunger 420 may be moved toward the core 410 by the magnetic force generated inside the solenoid 100 to open the valve.

Referring to FIG. 4, when abnormal power is applied to the solenoid 100, the variable resistor R may interrupt the supply of the abnormal power to the first coil L1 to protect the first coil L1. Here, the abnormal power may be an over-voltage higher than or equal to the rated voltage of the solenoid 100 or an over-current higher than or equal to the rated current of the solenoid 100. For example, when an over-voltage (or over-current) is applied to the solenoid 100 due to a failure in the drive device 200 and/or the controller 300, the amount of heat generated from the first coil L1 may be rapidly increased. At this time, the variable resistor R may interrupt the power supplied to the first coil L1 to decrease the amount of heat generated from the first coil L1. In a case where the variable resistor R is a PTC element, the resistance of the PTC element may be rapidly increased from 0.01Ω to 3000Ω to interrupt the supply of power to the first coil L1 when ambient temperature due to heat generated from the first coil L1 reaches a temperature at which the PTC element is triggered and/or when current applied to the PTC element reaches a current at which the PTC element is triggered.

Because a high-resistance coil is used as the second coil L2, even when abnormal power is applied to the solenoid 100, low current flows through the second coil L2, and thus the second coil L2 is not overheated. Accordingly, even in a state in which abnormal power is applied to the solenoid 100 so that operation of the first coil L1 is stopped, the valve remains open by a magnetic force generated by the second coil L2.

When the solenoid 100 according to the disclosed embodiments is applied to a high-pressure hydrogen valve, the withstanding voltage performance of the high-pressure hydrogen valve may be improved, and stability of a user and/or a stack may be improved in an over-voltage situation during travel of a vehicle. For example, when the solenoid 100 according to the embodiments is applied to a fuel valve, emergency braking by fuel cut off during travel of a vehicle may be prevented, and degradation in the durability of a stack due to improper fuel supply may be prevented.

According to the present disclosure, the solenoid may be protected from an over-voltage or over-current by applying the dual coils and the PTC element to the solenoid.

Hereinabove, although the present disclosure has been described with reference to specific embodiments and the accompanying drawings, the present disclosure is not limited thereto. The embodiments may be variously modified and altered by those having ordinary skill in the art to which the present disclosure pertains without departing from the spirit and scope of the present disclosure claimed in the following claims. Therefore, the embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure. cm What is claimed is:

1. A solenoid comprising:
a first coil;
a variable resistor connected to one end of the first coil in series; and
a second coil connected with the first coil in parallel.

2. The solenoid of claim 1, wherein the first coil is implemented with a coil having a relatively low resistance, compared to the second coil.

3. The solenoid of claim 1, wherein the variable resistor is implemented with a positive temperature coefficient (PTC) element.

4. The solenoid of claim 1, wherein the variable resistor interrupts power applied to the first coil, when abnormal power is applied to the solenoid.

5. A solenoid control device comprising:
a solenoid including dual coils;
a drive device configured to drive the solenoid by supplying power to the dual coils; and
a controller configured to control the solenoid through the drive device.

6. The solenoid control device of claim 5, wherein the dual coils include:
a first coil; and
a second coil connected with the first coil in parallel.

7. The solenoid control device of claim 6, wherein the first coil is implemented with a coil having a relatively low resistance, compared to the second coil.

8. The solenoid control device of claim 6, wherein the solenoid includes a variable resistor connected to the first coil in series.

9. The solenoid control device of claim 8, wherein the variable resistor is implemented with a positive temperature coefficient (PTC) element.

10. The solenoid control device of claim 8, wherein the variable resistor interrupts power applied to the first coil, when abnormal power is applied to the solenoid.

11. The solenoid control device of claim 10, wherein the controller outputs a warning to inform of the application of the abnormal power to the solenoid.
